(19) United States
(12) Patent Application Publication
(10) Pub. No.: US 2023/0401956 A1
(43) Pub. Date: Dec. 14, 2023

(54) INFORMATION PROVIDING SYSTEM, SERVER, INFORMATION PROVIDING METHOD, AND COMPUTER PROGRAM

(71) Applicant: Sumitomo Electric Industries, Ltd., Osaka-shi, Osaka (JP)

(72) Inventors: Yu NISHIMOTO, Osaka-shi, Osaka (JP); Masahiro NAKAJIMA, Osaka-shi, Osaka (JP); Masayuki YAMAMOTO, Osaka-shi, Osaka (JP); Tsuyoshi HAGA, Osaka-shi, Osaka (JP)

(73) Assignee: Sumitomo Electric Industries, Ltd., Osaka-shi, Osaka (JP)

(21) Appl. No.: 18/032,820

(22) PCT Filed: Sep. 2, 2021
(86) PCT No.: PCT/JP2021/032331

§ 371 Date: Apr. 20, 2023

(30) Foreign Application Priority Data
Oct. 23, 2020 (JP) 2020-178008

(51) Int. Cl. G08G 1/0967; G01C 21/34; G01C 21/36

(52) U.S. Cl. CPC G08G 1/0967; G01C 21/3461; G01C 21/3694

(57) ABSTRACT

An information providing system includes a mobile terminal and a server. The server includes a dynamic information acquiring unit configured to sequentially acquire dynamic information including location information of the mobile terminal and weather information of an area where the mobile terminal is located, a static information acquiring unit configured to acquire static information including hazard map information indicating a predicted area where occurrence of a weather disaster in an assumed weather state is predicted, the assumed weather state being a weather state in which the occurrence of the weather disaster is predicted, a setting unit configured to set a dangerous area in the predicted area based on the dynamic information and the static information, the dangerous area being an area where user of the mobile terminal is at risk, and a communication control unit configured to transmit information on the dangerous area to mobile terminal.

### TECHNICAL FIELD

The present disclosure relates to an information providing system, a server, an information providing method, and a computer program. This application claims priority based on Japanese Patent Application No. 2020-178008 filed on Oct. 23, 2020, the entire contents of which are incorporated herein by reference.

### BACKGROUND ART

PTL 1 discloses a navigation system that searches for a guidance route that is safe for passengers of a vehicle and performs guidance on the guidance route when emergency information is received at the time of disaster occurrence. The navigation system is configured to search for a guided route in response to reception of emergency information emitted at the occurrence of a natural disaster.

### CITATION LIST

### Patent Literature

PTL 1: Japanese Unexamined Patent Application Publication No. 2005-321323

### SUMMARY OF THE INVENTION

An information providing system according to an embodiment includes a mobile terminal and a server capable of communicating with the mobile terminal. The server includes a dynamic information acquiring unit configured to sequentially acquire dynamic information including location information of the mobile terminal and weather information of an area where the mobile terminal is located, a static information acquiring unit configured to acquire static information including hazard map information indicating a predicted area where occurrence of a weather disaster in an assumed weather state is predicted, the assumed weather state being a weather state in which the occurrence of the weather disaster is predicted, a setting unit configured to set a dangerous area in the predicted area based on the dynamic information and the static information, the dangerous area being an area where an user of the mobile terminal is likely to be at risk, and a communication control unit configured to transmit information on the dangerous area to the mobile terminal. The setting unit is configured to set the dangerous area before a weather state indicated by the sequentially acquired information becomes the assumed weather state.

A server capable of communicating with a mobile terminal according to another embodiment includes a dynamic information acquiring unit configured to sequentially acquire dynamic information including location information of the mobile terminal and weather information of an area where the mobile terminal is located, a static information acquiring unit configured to acquire static information including hazard map information indicating a predicted area where occurrence of a weather disaster in an assumed weather state is predicted, the assumed weather state being a weather state in which the occurrence of the weather disaster is predicted, a setting unit configured to set a dangerous area in the predicted area based on the dynamic information and the static information, the dangerous area being an area where an user of the mobile terminal is likely to be at risk, and a communication control unit configured to transmit information on the dangerous area to the mobile terminal. The setting unit is configured to set the dangerous area before a weather state indicated by the sequentially acquired information becomes the assumed weather state.

An information providing method for providing information to a mobile terminal according to another aspect of the embodiment includes sequentially acquiring dynamic information including location information of the mobile terminal and weather information of an area where the mobile terminal is located, acquiring static information including hazard map information indicating a predicted area where occurrence of a weather disaster in an assumed weather state is predicted, the assumed weather state being a weather state in which the occurrence of the weather disaster is predicted, setting a dangerous area in the predicted area based on the dynamic information and the static information, the dangerous area being an area where an user of the mobile terminal is likely to be at risk, and transmitting information on the dangerous area to the mobile terminal, in the setting, the dangerous area is set before a weather state indicated by the sequentially acquired information becomes the assumed weather state.

A computer program for causing a computer to execute a process for providing information to a mobile terminal according to another aspect of the embodiment causes the computer to execute sequentially acquiring dynamic information including location information of the mobile terminal and weather information of an area where the mobile terminal is located, acquiring static information including hazard neap information indicating a predicted area where occurrence of a weather disaster in an assumed weather state is predicted, the assumed weather state being a weather state in which the occurrence of the weather disaster is predicted, setting a dangerous area in the predicted area based on the dynamic information and the static information, the dangerous area being an area where an user of the mobile terminal is likely to be at risk, and transmitting information on the dangerous area to the mobile terminal. In the setting, the dangerous area is set before a weather state indicated by the sequentially acquired information becomes the assumed weather state.

### BRIEF DESCRIPTION OF TILE DRAWINGS

FIG. 1 is a diagram illustrating an example of an overall configuration of an information providing system.

FIG. 2 is a diagram illustrating an example of a flood disaster hazard map.

FIG. 3 is a sequence diagram illustrating an example of processing performed in an information providing server and an user terminal according to a first embodiment.

FIG. 4 is a diagram illustrating a display screen of a display apparatus, and illustrates an example when an avoidance route, a dangerous area, and a dangerous section are displayed.

FIG. 5 is a sequence diagram illustrating an example of processing performed in the information providing server and the user terminal according to a second embodiment.

FIG. 6 is a diagram illustrating a display screen of the display apparatus, and illustrates an example when a dangerous area is displayed,

FIG. 7 is a diagram illustrating a display screen of the display apparatus, and illustrates another example when a dangerous area is displayed.

FIG. 8 is a diagram illustrating a display screen of the display apparatus, illustrates a case where the amount of rainfall exceeds the assumed amount of rainfall while the user terminal shown in FIG. 7 is located in the dangerous area.

FIG. 9 is a block diagram illustrating a configuration example of the information providing server according to each of the above embodiments.

FIG. 10 is a functional block diagram illustrating an example of the functions of the information providing server.

FIG. 11 is a block diagram illustrating a configuration example of the user terminal according to each of the above embodiments.

FIG. 12 is a functional block diagram illustrating an example of the functions of an user terminal.

### DETAILED DESCRIPTION

### Problems to be Solved by Present Disclosure

However, in the system of PTL 1, since information provision for guidance is started after occurrence of a natural disaster, there is a possibility that choices of guidance routes are narrowed, guidance on a guidance route with a high danger level has to be provided, or appropriate information on a disaster cannot be provided.

### Advantageous Effects of Present Disclosure

According to the present disclosure, it is possible to appropriately provide information on a weather disaster.

### DESCRIPTION OF EMBODIMENTS OF PRESENT DISCLOSURE

First, contents of the embodiments will be listed and described.
(1) An information providing system according to an embodiment includes a mobile terminal and a server capable of communicating with the mobile terminal. The server includes a dynamic information acquiring unit configured to sequentially acquire dynamic information including location information of the mobile terminal and weather information of an area where the mobile terminal is located, a static information acquiring unit configured to acquire static information including hazard map information indicating a predicted area where occurrence of a weather disaster in an assumed weather state is predicted, the assumed weather state being a weather state in which the occurrence of the weather disaster is predicted, a setting unit configured to set a dangerous area in the predicted area based on the dynamic information and the static information, the dangerous area being an area where an user of the mobile terminal is likely to be at risk, and a communication control unit configured to transmit information on the dangerous area to the mobile terminal. The setting unit is configured to set the dangerous area before a weather state indicated by the sequentially acquired information becomes the assumed weather state.

According to the above configuration, since the dangerous area is determined before the weather state reaches the assumed weather state of the predicted area, it is possible to determine the dangerous area before the occurrence of the weather disaster. Thus, the information about the dangerous area can be transmitted to the mobile terminal before the occurrence of the weather disaster. Therefore, it is possible to appropriately provide the mobile terminal with weather disaster to the mobile terminal.
(2) In the information providing system, the server may further include a route setting unit configured to set a guide route based on a departure point and an arrival point provided from the mobile terminal. The setting unit may be configured to set, as the dangerous area, an area through which the guide route passes in a travel direction from a location of the mobile terminal in the predicted area. In this case, it is possible to inform the mobile terminal that there is a dangerous area on the guide route and display it on the mobile terminal.
(3) In the information providing system, the mobile terminal may include a display unit configured to display the information on the dangerous area that has been received. The route setting unit may be configured to set, in response to the dangerous area being set, an avoidance route for avoiding a dangerous section passing through the dangerous area in the guide route. The information on the dangerous area may include information indicating the dangerous section and information indicating the avoidance route. The display unit may be configured to display the avoidance route and the dangerous section so as to be superimposed on a map image in mutually different display forms. In this case, both the avoidance route that can avoid the dangerous area and the dangerous section that passes through the dangerous area can be distinguishably displayed to the user of the mobile terminal. As a result, it is possible to prompt the user to avoid the dangerous area and to wam the user that the dangerous section should not be entered as a route.
(4) In the information providing system, the weather state may include an amount of rainfall. The predicted area may be an area where occurrence of a weather disaster caused by rainfall is predicted. The assumed weather state may include an assumed amount of rainfall. In this case, the setting unit sets a dangerous area in which occurrence of a weather disaster caused by rainfall is predicted, Therefore, it is possible to appropriately provide information on a weather disaster caused by a rainfall.
(5) In the information providing system, the setting unit may be configured to set the dangerous area if the amount of rainfall is greater than a predetermined threshold. The predetermined threshold may be less than the assumed amount of rainfall. In this case, the dangerous area can be defined while the possibility of occurrence of the weather disaster is low in the predicted area. Therefore, it is possible to transmit the information on the dangerous area to the mobile terminal at a timing at which the possibility of occurrence of the weather disaster is low.
(6) In the information providing system, the weather state may include an amount of rainfall. The predicted area may be an area where occurrence of a weather disaster caused by rainfall is predicted. The assumed weather state may include an assumed amount of rainfall. The communication control unit may be configured to transmit, if the amount of rainfall is greater than the assumed amount of rainfall, increase information to the mobile terminal, the increase information indicating that the amount of rainfall has increased. The display unit may be configured to change, in response to receipt of the increase information, the display form of the dangerous section. In this case, the display fomi of the dangerous section may be changed depending on whether or not the amount of rainfall is greater than the assumed amount of rainfall, and the warning level may be changed depending on the degree of risk in the dangerous section.
(7) In the information providing system, the setting unit may be configured to se, as the dangerous area, an area overlapping with a periphery area set on a periphery of the mobile terminal in the predicted area. In this case, it is possible to inform the mobile terminal that there is a dangerous area around the mobile terminal or that the mobile terminal is located in the dangerous area, and to display it on the mobile terminal.
(8) In the information providing system, the mobile terminal may include a display unit configured to display the information on the dangerous area that has been received. The information on the dangerous area may include location information of the dangerous area. The display unit may be configured to display the dangerous area and a location of the mobile terminal so as to be superimposed on a map image. In this case, the relative location relationship between the current location and the dangerous area can be displayed to the user of the mobile terminal.
(9) In the information providing system, the weather state may include an amount of rainfall. The predicted area may be an area where occurrence of a weather disaster caused by rainfall is predicted. The assumed weather state may include an assumed amount of rainfall. The communication control unit may be configured to transmit, if the amount of rainfall is greater than the assumed amount of rainfall, increase information to the mobile terminal, the increase information indicating that the amount of rainfall has increased. The display unit may be configured to change, in response to receipt of the increase information, a display form of the dangerous area. In this case, the display form of the dangerous area may be changed depending on whether or not the amount of rainfall is greater than the assumed amount of rainfall, and the warning level may be changed depending on the degree of risk in the dangerous area.
(10) In the information providing system, the weather state may include an amount of rainfall. The predicted area may be an area where occurrence of a weather disaster caused by rainfall is predicted. The assumed weather state may include an assumed amount of rainfall. The communication control unit may be configured to transmit, if the amount of rainfall is greater than the assumed amount of rainfall, location information to the mobile terminal, the location information being location information of an evacuation site around the mobile terminal. In this case, when the amount of rainfall becomes larger than the assumed amount of rainfall and the danger level in the dangerous area increases, the location of the evacuation site is displayed to the user of the mobile terminal, so that the user of the mobile terminal can be guided to the evacuation site.
(11) A server capable of communicating with a mobile terminal according to another embodiment includes a dynamic information acquiring unit configured to sequentially acquire dynamic information including location information of the mobile terminal and weather information of an area where the mobile terminal is located, a static information acquiring unit configured to acquire static information including hazard map information indicating a predicted area where occurrence of a weather disaster in an assumed weather state is predicted, the assumed weather state being a weather state in which the occurrence of the weather disaster is predicted, a setting unit configured to set a dangerous area in the predicted area based on the dynamic information and the static information, the dangerous area being an area where an user of the mobile terminal is likely to be at risk, and a communication control unit configured to transmit information on the dangerous area to the mobile terminal. The setting unit is configured to set the dangerous area before a weather state indicated by the sequentially acquired information becomes the assumed weather state.
(12) An information providing method for providing information to a mobile terminal according to another aspect of the embodiment includes sequentially acquiring dynamic information including location information of the mobile terminal and weather information of an area where the mobile terminal is located, acquiring static information including hazard map information indicating a predicted area where occurrence of a weather disaster in an assumed weather state is predicted, the assumed weather state being a weather state in which the occurrence of the weather disaster is predicted, setting a dangerous area in the predicted area based on the dynamic information and the static information, the dangerous area being an area where an user of the mobile terminal is likely to be at risk, and transmitting information on the dangerous area to the mobile terminal. In the setting, the dangerous area is set before a weather state indicated by the sequentially acquired information becomes the assumed weather state.
(13) A computer program for causing a computer to execute a process for providing information to a mobile terminal according to another aspect of the embodiment causes the computer to execute sequentially acquiring dynamic information including location information of the mobile terminal and weather information area where the mobile terminal is located, acquiring static information including hazard map information indicating a predicted area where occurrence of a weather disaster in an assumed weather state is predicted, the assumed weather state being a weather state in which the occurrence of the weather disaster is predicted, setting a dangerous area in the predicted area based on the dynamic information and the static information, the dangerous area being an area where an user of the mobile terminal is likely to be at risk, and transmitting information on the dangerous area to the mobile terminal. In the setting, the dangerous area is set before a weather state indicated by the sequentially acquired information becomes the assumed weather state.

### Details of Embodiments

Hereinafter, preferred embodiments will be described with reference to the drawings. At least a part of each embodiment described below may be arbitrarily combined.

[Overall Configuration]

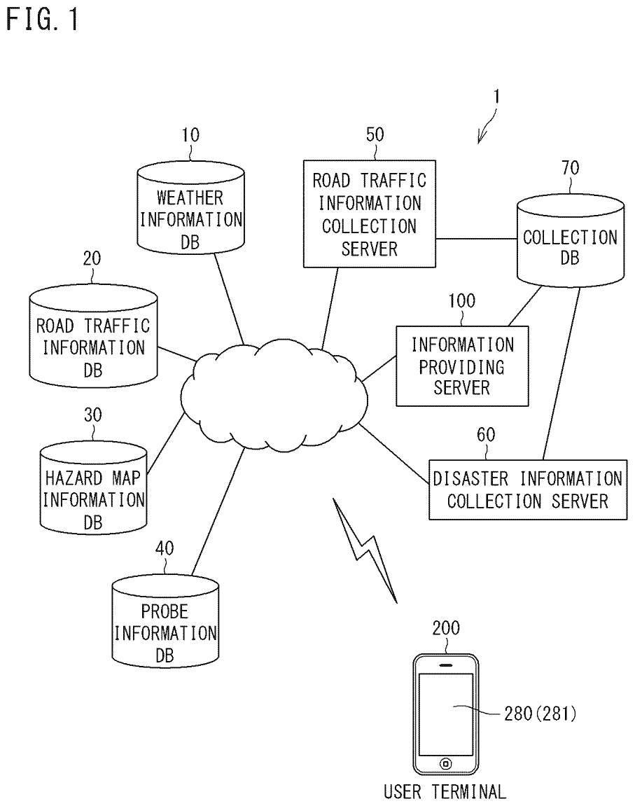

FIG. 1 is a diagram illustrating an example of an overall configuration of an information providing system. An information providing system 1 according to an embodiment of the present disclosure includes a weather information database (hereinafter, “database” is also referred to as “DB”) 10, a road traffic information DB 20, a hazard map information DB 30, a probe information DB 40, a road traffic information collection server 50, a disaster information collection server 60, a collection DB 70, an information providing server 100, and an user terminal 200. Each of weather information DB 10, road traffic information DB 20, hazard map information DB 30, probe information DB 40, road traffic information collection server 50, disaster information collection server 60, information providing server 100, and user terminal 200 can communicate with each other via a wide area network 300.

Weather information DB 10 collects and stores weather information of each area issued by the Meteorological Agency or the like. The weather information includes disaster prevention information and weather data. The disaster prevention information includes information on rainfall (heavy rain emergency warning, heavy rain alarm, heavy rain caution), information on river flooding (flood danger information, flood warning information, flood caution information), information on landslide disaster (landslide disaster warning information), information on high tide (high tide emergency warning, high tide alarm, high tide caution, etc.), and information on flood (flood alarm, flood caution). The weather data includes an amount of rainfall (amount of snow), a wind direction, a wind speed, and the like. The disaster prevention information includes a warning level issued by a self-governing body or the like based on the information. A state at a certain time point of a situation indicated by the disaster prevention information and the weather data Which change with time is referred to as a weather state.

Road traffic information DB 20 collects and stores real-time road traffic information. The road traffic information includes accident information, congestion information, traffic jam information, road closure information, traffic regulation information, and the like.

Hazard map information DB 30 collects and stores hazard map information of each area. The hazard map information includes, for example, the content of a hazard map created by a self-governing body or the like as information. In the hazard map, an area (predicted area) in which occurrence of a disaster is predicted in the target area is indicated. The hazard map information includes information indicating a predicted area. The information indicating the predicted area includes location information such as map coordinates indicating a location and a range of the area.

In an embodiment of the present disclosure, hazard map information DB 30 collects and stores hazard map information related to weather disasters. Hazard map information DB 30 collects and stores flood disaster hazard map information, landslide disaster hazard map information, road disaster prevention information hazard map information, high tide disaster hazard map information, and the like as hazard map information relating to weather disasters. The flood disaster hazard map information includes location information of an area in which occurrence of a flood disaster is predicted due to flooding of a river, collapse of a storage reservoir, or the like. The landslide hazard map information includes location information of an area in which occurrence of a landslide hazard is predicted, such as a landslide hazard warning zone and a landslide hazard special warning zone. In addition, the road disaster prevention information hazard map information includes location information of areas (roads) in which traffic is restricted at the time of a disaster, such as an expected flood point and an advance traffic restriction section. The high tide disaster hazard map information includes location information of an area in which occurrence of a high tide disaster is predicted.

In addition, the hazard map information related to the weather disaster includes information indicating an assumed weather state being a weather state which is assumed when the predicted area is predicted. The predicted area indicates an area in which occurrence of a weather disaster is predicted in the assumed weather state. When creating a hazard map related to a weather disaster, an assumed weather state is set, and a predicted area is set based on the assumed weather state. The cause of occurrence of flood disaster and landslide disaster is mainly rainfall. For this reason, the assumed amount of rainfall is se as the assumed weather state in the flood disaster hazard map, the landslide disaster hazard map, and the road disaster prevention information hazard map. The assumed amount of rainfall indicates an amount of rainfall assumed to predict the predicted area when the hazard map is created. That is, the predicted area of the hazard map indicates an area in which the disaster occurrence is predicted when the assumed amount of rainfall is reached. The assumed amount of rainfall is set according to predetermined criteria. The amount of rainfall in the hazard map information is represented by an unit determined for each hazard map, such as an amount of rainfall per predetermined time. Information indicating the assumed amount of rainfall is included in the flood disaster hazard map information, the landslide disaster hazard map information, and the road disaster prevention information hazard map information.

Further, the flood disaster hazard map information, the landslide disaster hazard map information, the road disaster prevention information hazard map information, and the high tide disaster hazard map information also include location information of an evacuation site.

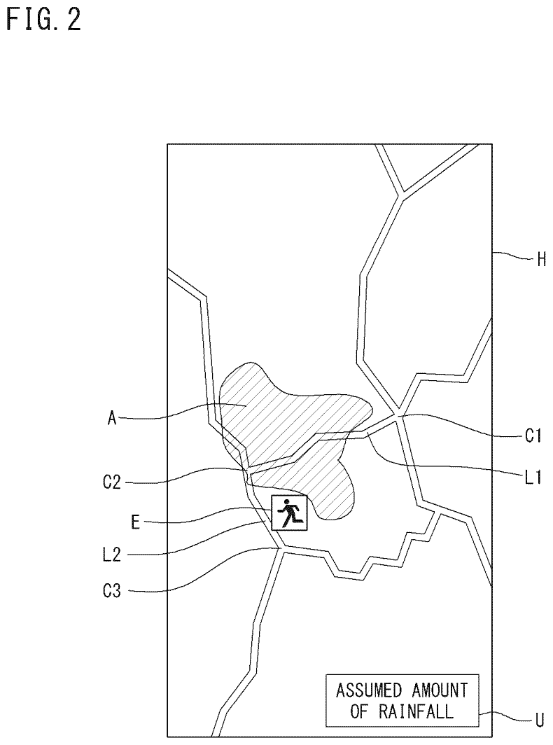

FIG. 2 illustrates an example of a flood disaster hazard map. FIG. 2 illustrates a portion of a flood disaster hazard map. In a flood disaster hazard map H, a predicted area A in which occurrence of a flood disaster is predicted when the assumed amount of rainfall is reached is indicated on a map of the target area. An evacuation site E is also indicated along with predicted area A. An assumed amount of rainfall U is also indicated in hazard map H. The flood disaster hazard map information includes location information indicating the location and range of predicted area A, assumed amount of rainfall U, and location information of evacuation site E in flood disaster hazard map H.

Returning to FIG. 1, probe information DB 40 collects and stores probe information. The probe information is information acquired from a traveling vehicle, and includes information on a traveling stale and a traveling track of the vehicle.

Road traffic information collection server 50 is configured by a computer. Road traffic information collection server 50 receives road traffic information of a specific point (road) from road traffic information DB 20 in response to, for example, a request. Road traffic information collection server 50 is connected to collection DB 70, and can store the received road traffic information in collection DB 70. Further, road traffic information collection server 50 receives probe information of a specific area from road traffic information DB 20 in response to a request, Road traffic information collection server 50 can store the received probe information in collection DB 70.

Disaster information collection server 60 is configured by a computer. Disaster information collection server 60 receives weather information of a specific area from weather information DB 10 in response to the request. Disaster information collection server 60 is connected to collection DB 70 and can store the received weather information in collection DB In addition, disaster information collection server 60 receives hazard map information of a specific area from hazard map information DB 30 in response to a request, Disaster information collection server 60 can store the received hazard map information in collection DB 70.

Information providing server 100 is configured by a computer. Information providing server 100 is connected to collection DB 70. Information providing server 100 can acquire road traffic information, probe information, weather information, and hazard map information from collection DB 70. Information providing server 100 has a function of determining a dangerous area in the predicted areas by using these pieces of information and transmitting information on the dangerous area to user terminal 200. The dangerous area is an area that may cause a danger to the user of user terminal 200. For example, by combining the weather information such as the amount of rainfall and the degree occurrence of the wave alarm with the threshold of the hazard map, it is possible to know which threshold of the hazard map the target area has in according to the weather information. This is referred to as a dangerous area. Information providing server 100 also has a function of obtaining a guide route based on a departure point and an arrival point given from user terminal 200 and transmitting the guide route to user terminal 200.

User terminal 200 is an example of a mobile terminal. User terminal 200 may be a portable information terminal such as a smartphone or a laptop computer, or may be an in-vehicle terminal mounted on a vehicle. User terminal 200 includes an input device and a display apparatus. The input device is, for example, a touch sensor, a keyboard, or the like. The display apparatus is a liquid crystal panel, an organic electro-luminescence (OEL) panel, or the like, A display apparatus 280 of user terminal 200 of the embodiment of the present disclosure is a liquid crystal panel that also functions as an input device. Display apparatus 280 includes a display screen 281.

User terminal 200 is used by an user. User terminal 200 is a client of information providing system 1, and the user can log in to information providing system 1 by using user terminal 200. User terminal 200 has a function of accepting input of a departure point, an arrival point, and the like by the user. In addition, user terminal 200 has a function of receiving information on a guide route or a dangerous area set by information providing server 100 and displaying the information on display screen 281 of display apparatus 280.

### First Embodiment

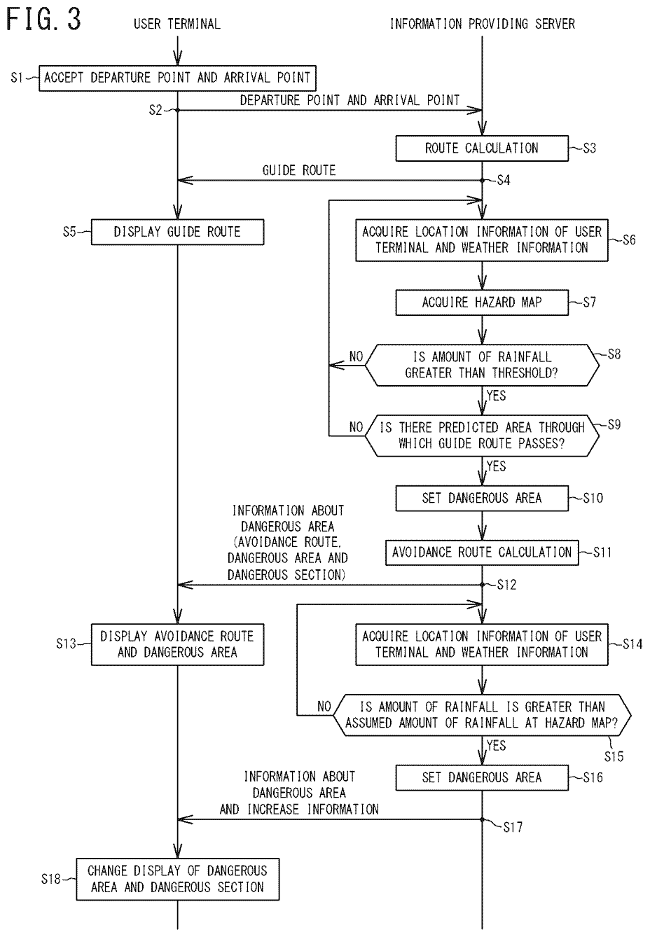

FIG. 3 is a sequence diagram illustrating an example of processing performed in information providing server 100 and user terminal 200 according to the first embodiment. FIG. 3 illustrates a case where the user of user terminal 200 searches for a route from a certain departure point to an arrival point and moves by vehicle or on foot.

First, user terminal 200 accepts a departure point and an arrival point input by the user (step S1), and transmits information indicating the accepted departure point and arrival point to information providing server 100 (step S2). Information providing server 100 that has received the information indicating the departure point and the arrival point performs route calculation for obtaining a guide route from the departure point to the arrival point (step S3). Information providing server 100 acquires road traffic information of an area including a departure point, an arrival point, a point through which the user may pass, and the like from collection DB 70. Based on the departure point, the arrival point, and the road traffic information, information providing server 100 obtains parameters such as the distance from the departure point to the arrival point, travel time, traffic regulation, and toll, and obtains a guide route appropriate for the user.

When the guide route is obtained by the route calculation, information providing server 100 transmits information indicating the obtained guide route to user terminal 200 (step S4). User terminal 200 that has received the information indicating the guide route displays the guide route on display apparatus 280 (step S5), and starts route guidance to the arrival point for the user.

While user terminal 200 performs route guidance to the arrival point, information providing server 100 performs processing related to setting of a dangerous area. That is, after transmitting the information indicating the wide route to user terminal 200, information providing server 100 acquires the location information of user terminal 200 and the weather information in the area where user terminal 200 is located (step S6).

User terminal 200 has a function of acquiring its own location information by a GPS receiver or the like included in user terminal 200. User terminal 200 can transmit the location information to information providing server 100 or another server. Information providing server 100 may acquire the location information of user terminal 200 from user terminal 200, or may acquire the location information of user terminal 200 from another server or database that collects the location information. Accordingly, information providing server 100 may recognize the current location of user terminal 200.

Information providing server 100 specifies an area where user terminal 200 is located based on the location information of user terminal 200, and acquires weather information of the area where user terminal 200 is located from collection DB 70. As described above, the weather information includes disaster prevention information and weather data. The location information of user terminal 200 and the weather information in the area where user terminal 200 is located may be dynamic information that changes over time. In step SC, information providing server 100 acquires dynamic information including location information of user terminal 200 and weather information in an area where user terminal 200 is located.

Next, information providing server 100 proceeds to step S7 and acquires hazard map information (step S7). Information providing server 100 acquires the hazard map information corresponding to the weather information from collection DB 70. For example, when information related to a rainfall such as a heavy rain warning is issued, information providing server 100 acquires hazard map information (flood disaster hazard map, landslide disaster hazard map, road disaster prevention information hazard map) of a disaster whose disaster occurrence cause is a rainfall. In addition, when the information on the high tide is issued, information providing server 100 acquires the high tide disaster hazard map information.

The hazard map information is static information that does not change over time. In step S7, information providing server 100 acquires hazard map information which is static information. In the following description, it is assumed that the information about the rainfall is issued and information providing server 100 acquires only the flood disaster hazard map information shown in FIG. 2 as the hazard map information.

In addition, information providing server 100 may execute the step S7 again after executing the subsequent step. In this case, if the previously acquired flood disaster hazard map information is available, since the hazard map information is static information, the previously acquired flood disaster hazard map information is used without newly acquiring the flood disaster hazard map information.

Next, information providing server 100 refers to the amount of rainfall as the information indicating the weather state in the acquired weather information, and determines whether or not the amount of rainfall is greater than a predetermined threshold (step S8). The amount of rainfall may be acquired in the same unit as the display unit of the assumed amount of rainfall included in the flood disaster hazard map information. For example. When the assumed amount of rainfall included in the flood disaster hazard map information is expressed as 500 mm per 48 hours, information providing server 100 may acquire the amount of rainfall per 48 hours as the amount of rainfall. Further, the threshold is set to a value smaller than the assumed amount of rainfall included in the flood disaster hazard map information. In an embodiment of the present disclosure, the threshold is set to a value of 80 percent of the assumed amount of rainfall. For example, when the assumed amount of rainfall included in the flood disaster hazard map information is expressed as 500 mm per 48 hours, the threshold may be 400 mm per 48 hours.

If it is determined in step S8 that the amount of rainfall is equal to or less than the threshold, information providing server 100 returns to step S6 again. When it is determined in step S8 that the amount of rainfall is greater than the threshold, information providing server 100 determines whether or not there is a predicted area through which the guide route passes among the predicted areas in the flood disaster hazard map information (step S9). Information providing server 100 determines whether or not there is a predicted area through which the guide route passes in the traveling direction from the current location of user terminal 200.

If it is determined in step S9 that there is no predicted area through which the guide route passes, information providing server 100 returns to step S6 again. If it is determined in step S9 that there is a predicted area through which the guide route passes, information providing server 100 proceeds to step S10 and sets a dangerous area. Here, when a plurality of predicted areas are included in the flood disaster hazard map information, information providing server 100 may set all of the plurality of predicted areas as dangerous areas. However, in the embodiment of the present disclosure, information providing server 100 determines a predicted area through which the guide route passes in the traveling direction from the location of user terminal 200 among the predicted areas in the flood disaster hazard map information as a dangerous area. As a result, it is possible to define the dangerous area within a range necessary and sufficient for user terminal 200.

For example, it is assumed that a road link L1 between an intersection C1 and an intersection C2 and a road link L2 between intersection C2 and an intersection C3 in FIG. 2 are guide routes located in the traveling direction of user terminal 200. Road links L1 and L2 pass through predicted area. A. Therefore, in this case, information providing server 100 determines predicted area A as a dangerous area.

In addition, information providing server 100 determines a section passing through the dangerous area in the guide route as a dangerous section. Information providing server 100 may set a range from a boundary of the dangerous area to a predetermined distance or a predetermined point in the guide route as well as a portion in which the guide route and the dangerous area overlap each other as the dangerous section. In the case of FIG. 2, the entire road link L1 including not only the portion within predicted area A which is the dangerous area in road link L1 but also the portion outside predicted area A is set as the dangerous section. Similarly, the entire road link L2 is set to the dangerous section. As described above, information providing server 100 may determine dangerous sections in units of road links,

As described above, information providing server 100 of the embodiment of the present disclosure sequentially acquires the dynamic information (the location information of user terminal 200 and the weather information) in the step S6, and determines the dangerous area and the dangerous section based on the sequentially acquired dynamic information and the flood disaster hazard map information which is the static information.

As shown in FIG. 3, when a dangerous area is set in step S10, information providing server 100 performs an avoidance route calculation for obtaining an avoidance route for avoiding the dangerous area (step S11). Information providing server 100 acquires road traffic information of an area including a current location, an arrival point, a point through which the user may pass, and the like from collection DB 70. In addition, information providing server 100 acquires probe information at a current location, an arrival point, a point through which the user may pass, and the like from collection DB 70, Further, information providing server 100 acquires weather information from collection DB 70. Information providing server 100 refers to congestion information, traffic jam information, road closure information, traffic regulation information, and the like included in the road traffic information. In addition, information providing server 100 refers to information related to a traveling track of the vehicle included in the probe information. Further, information providing server 100 refers to disaster prevention information included in the weather information.

Information providing server 100 excludes the route where it is difficult to pass from the avoidance route by referring to the congestion information, the traffic jam information, the road closure information, the traffic regulation information, and the like. Information providing server 100 refers to the information related to the traveling track included in the probe information, and thus can recognize the route where the congestion occurs and the route where the traffic is difficult to pass before the road traffic information. As described above, since the current traffic situation may be grasped more quickly, information providing server 100 can obtain an appropriate avoidance route.

Information providing server 100 uses these pieces of information to determine an avoidance route appropriate for the user. In addition, information providing server 100 excludes a dangerous section from candidates of the avoidance route. Accordingly, information providing server 100 can obtain an avoidance route capable of avoiding a dangerous area. When user terminal 200 is located in the dangerous section, information providing server 100 does not exclude the dangerous section from candidates of the avoidance route, and obtains a route that can appropriately exit from the dangerous section and go to the arrival point while avoiding the dangerous area based on the above-described various kinds of information.

When the avoidance route is obtained, information providing server 100 transmits information on the dangerous area to user terminal 200 (step S12). The information about the dangerous area includes information indicating an avoidance route, location information of the dangerous area, and information indicating a dangerous section. The location information of the predicted area included in the flood disaster hazard map information is used as the location information of the dangerous area. The information indicating avoidance route and the information indicating dangerous section include information indicating road links and nodes representing respective routes and sections, and the like.

User terminal 200 received information about the dangerous area displays the current location, the avoidance route, the dangerous area, and the dangerous section of user terminal 200 on display apparatus 280 (step S13), and performs route guidance based on the avoidance route.

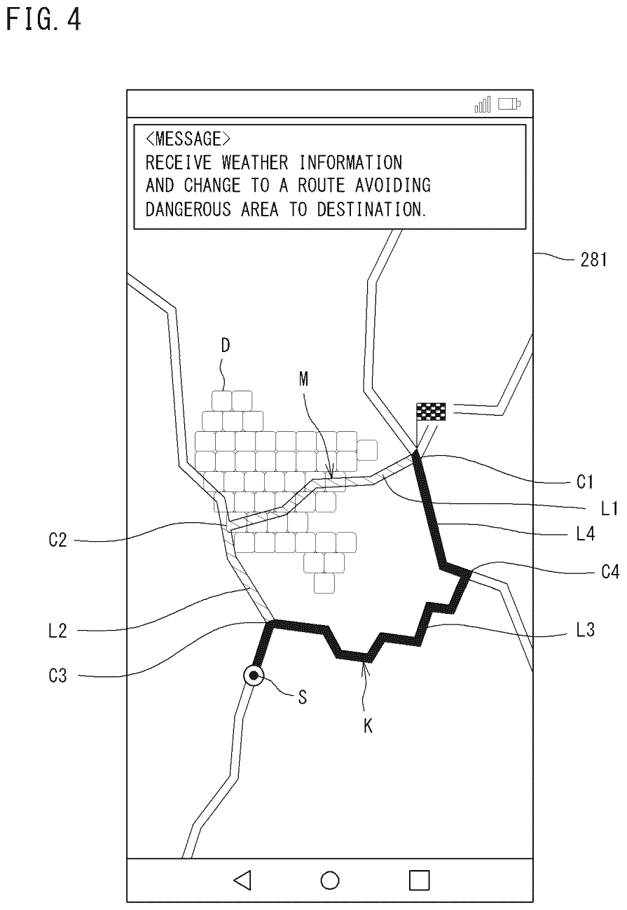

FIG. 4 is a diagram illustrating display screen 281 of display apparatus 280, and illustrates an example when the avoidance route, the dangerous area, and the dangerous section are displayed. FIG. 4 illustrates the same area as the flood disaster hazard map information shown in FIG. 2. As shown in FIG. 4, various kinds of information are superimposed on the map image of the area where user terminal 200 is located.

A dangerous area D corresponds to predicted area A in the flood disaster hazard map information shown in FIG. 2. User terminal 200 displays dangerous area D by arranging a number of rectangular figures.

An avoidance route K extends from a current location S of user terminal 200 indicated by a circle to intersection C1 via intersections C3 and C4. This intersection C1 is the arrival point. Avoidance route K includes a section from current location S to intersection C3, a road link L3 between intersection C3 and intersection C4, and a road link L4 between intersection C4 and intersection C1. User terminal 200 displays avoidance route K as a linear figure along the section from current location S to intersection C3 and road links L3 and L4.

As shown in FIG. 4, a dangerous section M is composed of road link L2 between intersection C2 and intersection C3 and road link L1 between intersection C1 and intersection C2. User terminal 200 displays dangerous section M by displaying a linear figure along road links L1 and L2, The linear figure representing avoidance route K and the linear figure representing dangerous section M are displayed in different display forms.

Accordingly, both avoidance route K that can avoid dangerous area D and dangerous section M that passes through dangerous area D can be distinguished and displayed on display screen 281 of display apparatus 280 for the user. At the same time, as shown in FIG. 4, by displaying a message on the screen indicating that the guide route has been changed to the avoidance route, it is possible to urge the user to avoid dangerous area D and to warn the user that dangerous section M should not be entered. In this way, it is possible to cause the user to recognize avoidance route K and dangerous section M, to prevent the user from entering dangerous section M, and to urge the user to move along avoidance route K.

The flood disaster hazard map information used in the embodiment of the present disclosure indicates a predicted area of a weather disaster (flood disaster) caused by a rainfall, and information providing server 100 is configured to determine the predicted area in the flood disaster hazard map information as a dangerous area when the amount of rainfall is greater than a threshold (steps S8-S10). Further, the threshold is set to a value less than the assumed amount of rainfall. Accordingly, information providing server 100 can determine the dangerous area from the predicted area before the amount of rainfall included in the sequentially acquired weather information reaches the assumed amount of rainfall. That is, the dangerous area may be determined while the possibility of occurrence of the flood disaster is low in the predicted area. Therefore, it is possible to transmit the information on the dangerous area to user terminal 200 at a timing at which the possibility of occurrence of the flood disaster is low.

As described above, in the embodiment of the present disclosure, since the dangerous area is determined in the predicted areas before the amount of rainfall reaches the assumed amount of rainfall, the dangerous area can be determined before the weather disaster occurrence. That is, by using the amount of rainfall included in the dynamic information and the flood disaster hazard map information included in the static information, it is possible to determine a dangerous area having a high possibility of a weather disaster occurrence before the weather disaster occurrence. Therefore, the information on the dangerous area can be transmitted to user terminal 200 before the occurrence of the weather disaster, and the information on the weather disaster can be appropriately provided to user terminal 200. As a result, it is possible to cause the user to recognize that the weather disaster is approaching and to call attention.

In addition, since information providing server 100 according to the embodiment of the present disclosure specifies a predicted occurrence area through which the guide route passes as a dangerous area, information providing server 100 may display on user terminal 200 that there is a dangerous area on the guide route.

As shown in FIG. 3, while user terminal 200 displays avoidance route, dangerous area, and dangerous section on display apparatus 280, information providing server 100 acquires location information of user terminal 200 and weather information from collection DB 70 (step S14) and repeatedly determines whether the amount of rainfall included in the weather information is greater than the assumed amount of rainfall (step S15).

If it is determined in step S15 that the amount of rainfall is greater than the assumed amount of rainfall, information providing server 100 sets a dangerous area as necessary (step S16), and transmits increase information indicating that the amount of rainfall has increased and information on the dangerous area to user terminal 200 (step S17). Since user terminal 200 moves, it may need to set another dangerous area in addition to the dangerous area set in step S10 as time elapses. In such a case, information providing server 100 sets another dangerous area (step S16) and transmits information on the other dangerous area with the increase information (step S17).

Upon receiving the increase information and the information about the dangerous area, user terminal 200 changes the display form of dangerous area D and dangerous section M on display screen 281 (step S18). In addition, when information about another dangerous area is acquired, user terminal 200 may display another dangerous area and a dangerous section passing through another dangerous area.

In this case, it is considered that the possibility of a flood disaster is extremely high in dangerous area D and dangerous section M. Therefore, user terminal 200 changes the display form of dangerous area D and dangerous section M and displays a warning in that entry into dangerous area D and dangerous section M is prohibited, thereby more strongly warning the user that entry into dangerous area D and dangerous section M is a danger.

As described above, when user terminal 200 receives the increase information, the display forms of dangerous area D and dangerous section M are changed. Thus, the display forms of dangerous area D and dangerous section M may be changed depending on whether the amount of rainfall is greater than the assumed amount of rainfall, and the warning level may be changed and displayed depending on the degree of risk in dangerous area D and dangerous section M.

In the embodiment of the present disclosure, the case where user terminal 200 displays the avoidance route, the dangerous area, and the dangerous section is exemplified. However, user terminal 200 may be configured to display the avoidance route and the dangerous section without displaying the dangerous area. Even in this case, the user can avoid the dangerous area by proceeding along the avoidance route.

### Second Embodiment

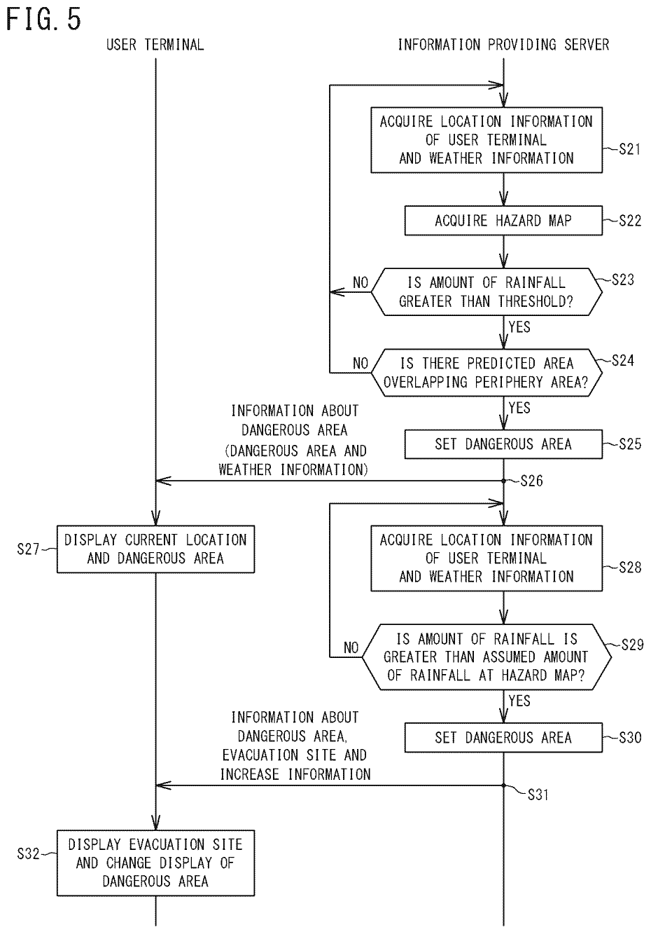

FIG. 5 is a sequence diagram illustrating an example of processing performed in information providing server 100 and user terminal 200 according to the second embodiment. FIG. 5 illustrates a case where the user of user terminal 200 moves without particularly determining an arrival point.

In FIG. 5, it is assumed that information providing server 100 monitors the movement of user terminal 200 in response to a request from user terminal 200. At first, information providing server 100 acquires location information of user terminal 200 and weather information in an area where user terminal 200 is located (step S21), and acquires hazard map information (step S22). Also in the embodiment of the present disclosure, it is assumed that information on rainfall is issued, and information providing server 100 acquires only the flood disaster hazard map information shown in FIG. 2 as hazard map information.

Next, information providing server 100 determines whether or not the amount of rainfall included in the weather information is greater than a predetermined threshold (step S23). This threshold is set to a value of 80 percent of the assumed amount of rainfall, as in the first embodiment. If it is determined in step S23 that the amount of rainfall is equal to or less than the threshold, information providing server 100 returns to step S21 again. When it is determined in step S23 that the amount of rainfall is greater than the threshold, information providing server 100 determines whether or not there is a predicted area overlapping a periphery area set around user terminal 200 among the predicted areas in the flood disaster hazard map information (step S24).

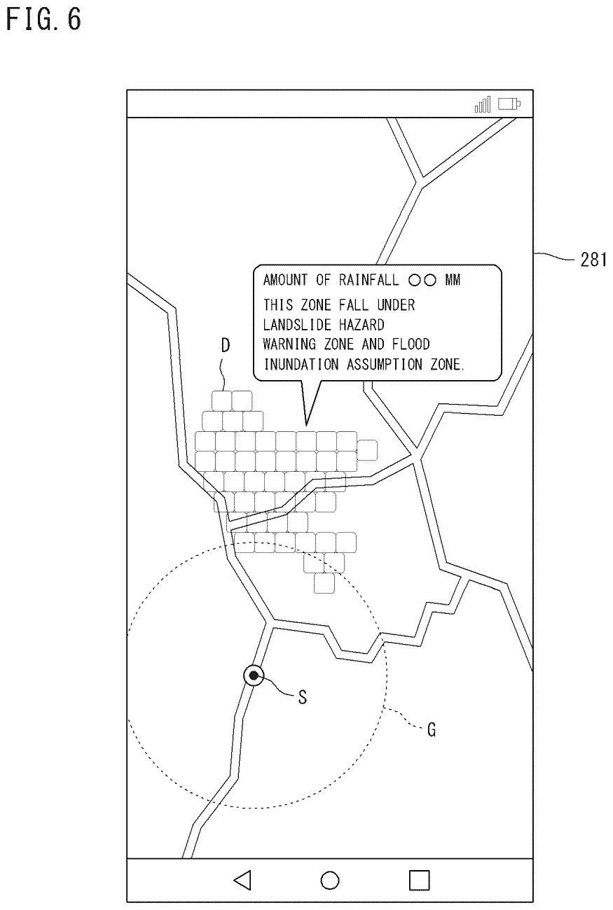

For example, information providing server 100 sets a circular range having a radius of 500 meters around the location of user terminal 200 as a periphery area (FIG. 6). If there is a predicted area that at least partially overlaps the periphery area, it can be determined that user terminal 200 is located in the predicted area or in the periphery of the predicted area.

In step S24, when it is determined that there is no predicted area overlapping the periphery area, information providing server 100 returns to step S21 again. If it is determined in step S24 that there is a predicted area overlapping the periphery area, information providing server 100 proceeds to step S25 and sets a dangerous area. This is because the predicted area overlapping with the periphery area is located around user terminal 200 and may be a dangerous area.

In step S25, information providing server 100 determines a predicted area overlapping with a periphery area as a dangerous area. Accordingly, it is possible to cause user terminal 200 to display that there is a dangerous area around user terminal 200 or that user terminal 200 is located in the dangerous area.

When the dangerous area is set, information providing server 100 transmits information on the dangerous area to user terminal 200 (step S26). The information on the dangerous area includes location information of the dangerous area and weather information. Upon receiving the information about the dangerous area, user terminal 200 displays the current location of user terminal 200 and the dangerous area on display apparatus 280 (step S27).

FIG. 6 is a diagram illustrating display screen 281 of display apparatus 280, showing an example when a dangerous area is displayed. FIG. 6 shows the same area as the flood disaster hazard map information shown in FIG. 2. Also in FIG. 6, similarly to the first embodiment, various kinds of information are superimposed on the map image of the area where user terminal 200 is located.

In FIG. 6, current location S and dangerous area D of user terminal 200 are displayed on the map image. FIG. 6 shows a case where user terminal 200 is located in the vicinity of dangerous area D. The predicted area corresponding to dangerous area. D is determined by information providing server 100 to be a predicted area overlapping a periphery area G, and is displayed as dangerous area. D as shown in FIG. 6. Therefore, dangerous area D shown in FIG. 6 appears to overlap periphery area G.

As shown in FIG. 6, by displaying current location S and dangerous area D of user terminal 200, the relative location relationship between the current location and dangerous area D can be displayed to the user. As a result, it is possible to cause the user to recognize that the weather disaster is approaching and to pay attention.

As shown in FIG. 6, user terminal 200 displays weather information on display apparatus 280 in addition to displaying the current location and dangerous area D of user terminal 200. The weather information displayed on display apparatus 280 includes weather data such as an amount of rainfall and information indicating a predicted weather disaster in dangerous area D. These pieces of information are displayed by, for example, touching the portion where dangerous area D is shown in display screen 281. This allows the user to recognize what kind of weather disaster is imminent.

Upon receiving the information on the dangerous area, user terminal 200 may issue a warning sound, vibration, or the like in addition to the display of dangerous area D. Thus, user terminal 200 can prompt the user to confirm the display of display apparatus 280.

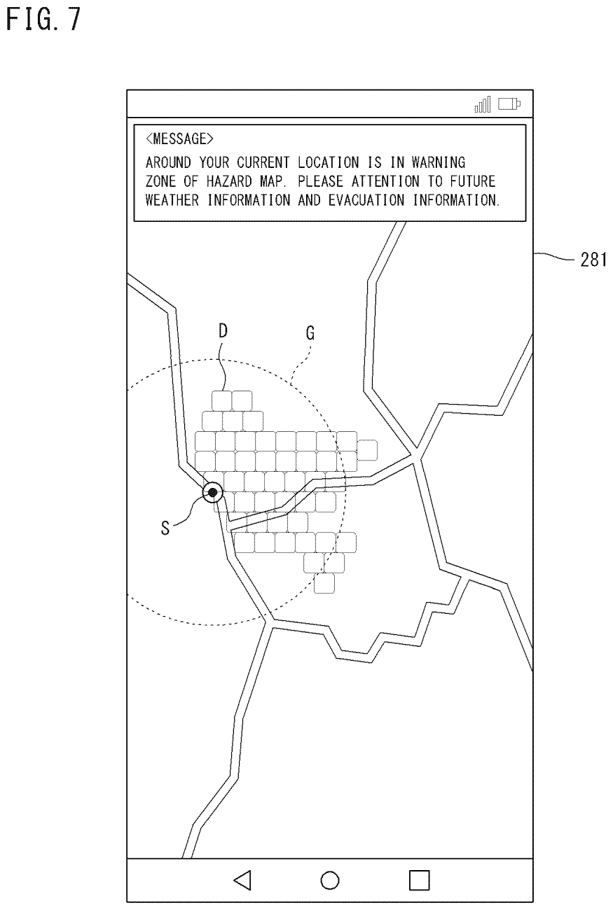

FIG. 7 is a diagram illustrating display screen 281 of display apparatus 280, showing another example when a dangerous area is displayed. FIG. 7 shows a case where user terminal 200 is located in dangerous area. D. Also in this case, the predicted area corresponding to dangerous area D is determined by information providing server 100 to be a predicted area overlapping periphery area G, and is displayed as dangerous area D as shown in FIG. 7. In addition to displaying current location S of user terminal 200 and dangerous area D, user terminal 200 displays a message or the like indicating that the user is located in dangerous area D as shown in FIG. 7, thereby more strongly alerting the user.

As shown in FIG. 5, while user terminal 200 displays current location S and dangerous area D of user terminal 200 on display apparatus 280, information providing server 100 acquires the location information of user terminal 200 and the weather information from collection DB 70 (step S28) and repeatedly determines whether the amount of rainfall included in the weather information is greater than the assumed amount of rainfall (step S29).

If it is determined in step S29 that the amount of rainfall is greater than the assumed amount of rainfall, information providing server 100 sets a dangerous area as necessary (step S30), and transmits increase information indicating that the amount of rainfall has increased, location information of the evacuation site, and information about the dangerous area to user terminal 200 (step S31). Information providing server 100 refers to the flood disaster hazard map information, acquires location information of an evacuation site located around the dangerous area, and transmits the location information. Since user terminal 200 moves, it may need to set another dangerous area in addition to the dangerous area set in step S25 as time elapses. In such a case, information providing server 100 sets another dangerous area (step S30) and transmits information on the other dangerous area with the increase information (step S31).

User terminal 200 that has received the increase information, the location information of the evacuation site, and the information about the dangerous area displays the evacuation site on display screen 281 and changes the display form of dangerous area D on display screen 281 (step S32).

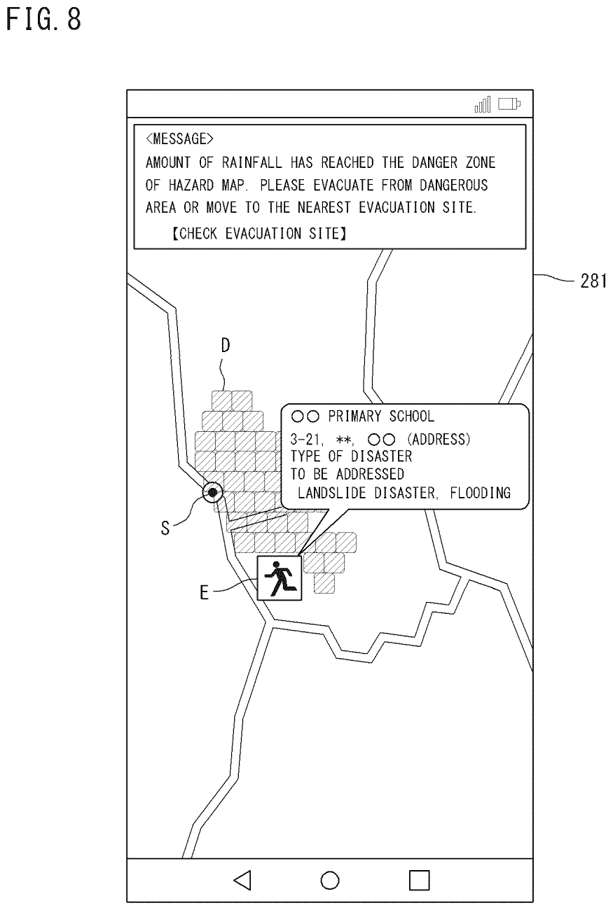

FIG. 8 shows display screen 281 of display apparatus 280 when the amount of rainfall exceeds the assumed amount of rainfall while user terminal 200 shown in FIG. 7 is located in dangerous area D. As shown in FIG. 8, user terminal 200 displays evacuation site E in addition to current location S and dangerous area D of user terminal 200. Further, user terminal 200 indicates evacuation site E and displays address information of evacuation site E, a disaster to which evacuation site E corresponds, and the like as a message. These pieces of information are displayed by, for example, touching the portion where evacuation site E is shown in display screen 281. As described above, when the amount of rainfall becomes larger than the assumed amount of rainfall and the danger level in dangerous area D is increased, the location of evacuation site E is displayed to the user, so that the user can be guided to evacuation site E.

In addition, user terminal 200 can change the display form of dangerous area D on display screen 281 depending on whether the amount of rainfall is greater than the assumed amount of rainfall to change the display form of dangerous area D on display screen 281. Thus, the warning level can be changed and displayed in accordance with the danger level in dangerous area D. Therefore, when the amount of rainfall is larger than the assumed amount of rainfall, the display form of dangerous area. D is changed so as to be more conspicuous than when the amount of rainfall is smaller than the assumed amount of rainfall, and thus it is possible to call attention more strongly.

[Configuration of Information Providing Server and User Terminal]

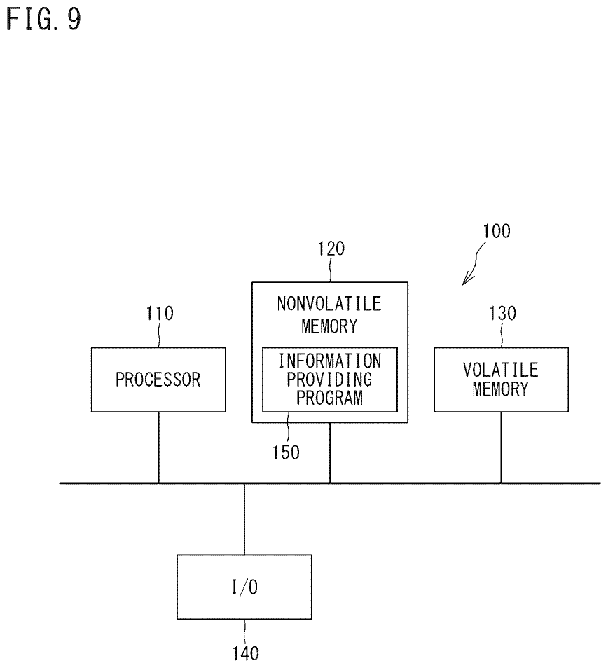

FIG. 9 is a block diagram illustrating a configuration example of information providing server 100 according to each of the above embodiments, Information providing server 100 includes a processor 110, a nonvolatile memory 120, a volatile memory 130, and an input/output interface 140, Volatile memory 130 is, for example, a static random access memory (SRAM), a dynamic random access memory (DRAM), or the like. Nonvolatile memory 120 is, for example, a flash memory, a hard disk, a read only memory (ROM), or the like. Nonvolatile memory 120 stores an information providing program 150, which is a computer program, and information used to execute information providing program 150. Each function of information providing server 100 described above is exhibited by information providing program 150 being executed by processor 110. Information providing program 150 can be stored in a recording medium such as a flash memory, a ROM, or a CD-ROM.

Processor 110 is, for example, a central processing unit (CPU). However, processor 110 is not limited to the CPU. Processor 110 may be a graphics processing unit (GPU) one specific example, processor 110 is a multi-core GPU. Processor 110 may be, for example, an application specific integrated circuit (ASIC) or a programmable logic device such as a gate array or a field programmable gate array (FPGA). In this case, the ASIC or the programmable logic device is configured to be able to execute the same processing as information providing program 150.

Input/output interface 140 includes, for example, an Ethernet interface (“Ethernet” is a registered trademark), and is connected to wide area network 300 and collection DB 70.

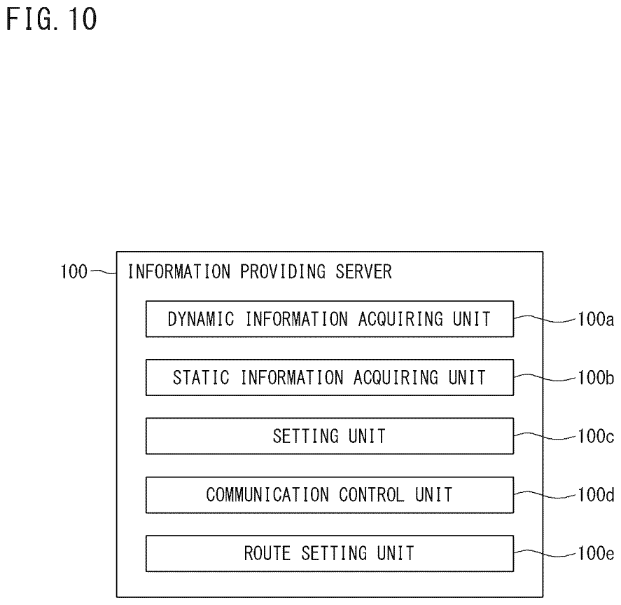

FIG. 10 is a functional block diagram illustrating an example of the functions of information providing server 100. Information providing server 100 functionally includes a dynamic information acquiring unit 100a, a static information acquiring unit 100, a setting unit 100c, a communication control unit 100d, and a route setting unit 100e. Dynamic information acquiring unit 100a functions to acquire location information of user terminal 200 and weather information of an area where user terminal 200 is located, which are dynamic information (steps S6 and S21). Static information acquiring unit 100b acquires hazard map information which is static information (steps S7 and S22).

Setting unit 100c has a function of determining a dangerous area based on the dynamic information and the static information (steps S10 and S25). In addition, setting unit 100c sets the dangerous area before the amount of rainfall, which is the sequentially acquired weather state, reaches the assumed amount of rainfall (assumed weather state). More specifically, setting unit 100c has a function of setting the predicted area indicated by the hazard map information as the dangerous area when the amount of rainfall which is the weather state is larger than a predetermined threshold (steps S8, S10, S23, S25), Setting unit 100c may have a function of determining, as a dangerous area, a predicted area through which the guide route passes in the traveling direction from the location of user terminal 200 among the predicted areas indicated by the hazard map information (steps S9 and S10). Setting unit 100c may have a function of determining, as a dangerous area, a predicted area overlapping a periphery area set around user terminal 200 among predicted areas indicated by the hazard map information (steps S24 and S25).

When setting unit 100c sets the dangerous area, communication control unit 100d transmits information about the dangerous area to user terminal 200 (steps S12 and S26). Communication control unit 100d may transmit the information indicating the dangerous section, the information indicating the avoidance route, and the location information of the dangerous area by including them in the information related to the dangerous area (steps S12 and S26). In addition, when the amount of rainfall is greater than the assumed amount of rainfall, communication control unit 100d may transmit increase information indicating that the amount of rainfall has increased and location information of evacuation sites around user terminal 200 to user terminal 200 (steps S17 and S31), Route setting unit 100e sets a guide route based on the departure point and the arrival point given from user terminal 200 (step S3). When the dangerous area is determined, route setting unit 100e also sets an avoidance route for avoiding the dangerous section passing through the predicted area among the guide routes (step S11).

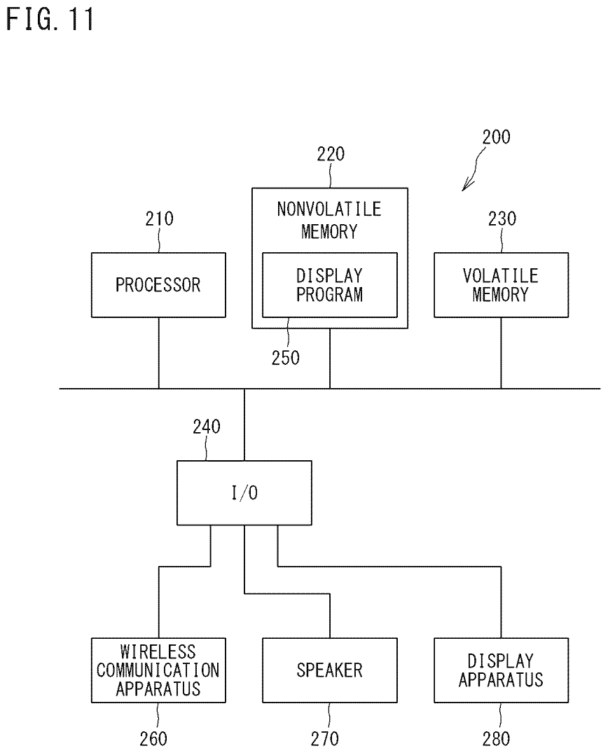

FIG. 11 is a block diagram illustrating a configuration example of user terminal 200 according to each of the above embodiments. User terminal 200 includes a processor 210, a nonvolatile memory 220, a volatile memory 230, an input/output interface 240, a wireless communication apparatus 260, a speaker 270, and the above-described display apparatus 280. Nonvolatile memory 220 stores a display program 250, which is a computer program, and date used to execute display program 250. The above-described functions of user terminal 200 are implemented when display program 250 is executed by processor 210, Wireless communication apparatus 260, speaker 270, and display apparatus 280 are connected to input/output interface 240.

Wireless communication apparatus 260 is, for example, a communication apparatus capable of communication connection with a base station apparatus or the like of a mobile communication system. User terminal 200 is connected to wide area network 300 through a mobile communication system. Speaker 270 is used to issue a warning sound when information on a dangerous area is received. As described above, display apparatus 280 is used to display information about a dangerous area.

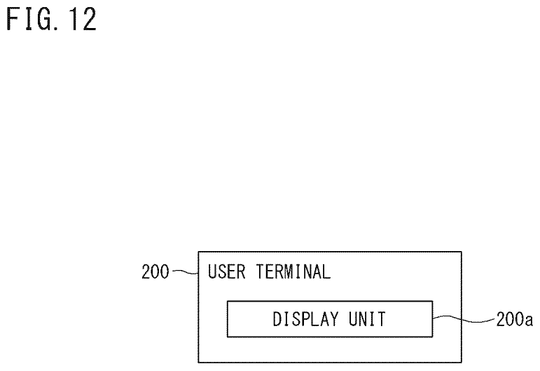

FIG. 12 is a functional block diagram illustrating an example of the functions of user terminal 200. User terminal 200 functionally includes a display unit 200a. Display unit 200a displays the received information about the dangerous area on display apparatus 280 (steps S13, S18, S27, and S32). Display unit 200a may have a function of superimposing the avoidance route and the dangerous section on the map image in different display forms and displaying the map image on display apparatus 280. In addition, display unit 200a may have a function of superimposing the dangerous area and the location of user terminal 200 on the map image and displaying the map image on display apparatus 280. In addition, display unit 200a may have a function of changing the display form of the dangerous section or the dangerous area upon receiving the increase information (steps S18 and S32), In addition, display unit 200a may have a function of displaying the location information of the evacuation site on display apparatus 280 upon receiving the increase information (step S32).

[Others]

It should be understood that the embodiments disclosed herein are illustrative in all respects and are not restrictive. In each of the above-described embodiments, the dangerous area is set by using the location information of user terminal 200 as the dynamic information and the amount of rainfall used as the weather state and using the flood disaster hazard map information as the static information. However, when the amount of rainfall is used as the weather state, the landslide disaster hazard map information and the road disaster prevention information hazard map information may be used as the hazard map information instead of the flood disaster hazard map information, or may be used in combination.

In addition, the threshold used in each of the above embodiments can be changed as necessary as long as it is a value smaller than the assumed amount of rainfall of the hazard map information.

In the above-described embodiment, the amount of rainfall is used as the weather state. However, instead of the amount of rainfall, it is possible to use information related to rainfall (heavy rain emergency warning, heavy rain alarm, heavy rain caution), information related to flooding of a river (flooding danger information, flooding warning information, flooding caution information), information related to high tide (high tide emergency warning, high tide alarm, high tide caution, etc.), information related to flood (flood alarm, flood caution), an alert level issued by a municipality or the like. These pieces of information are information for displaying the weather state in stages. For example, if a heavy rain alarm is issued at a timing not reaching the assumed amount of rainfall set in the hazard map information and a heavy rain emergency warning is issued in an amount equivalent to the assumed amount of rainfall set in the hazard map information in the information relating to rainfall, when the heavy rain alarm is acquired as the weather state, information providing server 100 can be caused to set a dangerous area. Thus, the dangerous area can be set before the heavy rain emergency warning corresponding to the assumed amount of rainfall is reached.

For example, when information on a rainfall is used as the information indicating the weather state, the dangerous area may be set using flood disaster hazard map information, landslide disaster hazard map information, and road disaster hazard map information in which the rainfall is the cause of occurrence. In this case, a dangerous area may not be set when a heavy rain warning is acquired as information on a rainfall, and the dangerous area is set when the heavy rain warning issued when the amount of rainfall further increases is acquired.

In addition, when information related to high tide is used as the information indicating the weather state, a dangerous area can be set using high tide disaster hazard map information.

In the first embodiment, information providing server 100 requests a guide route (step S3 in FIG. 3), transmits a guide route (step S4 in FIG. 3), and performs processing related to a dangerous area (steps S6 to S11 in FIG. 3), but the present invention is not limited thereto. After requesting the guide route (step S3 in FIG. 3), information providing server 100 may execute steps S6 to S9 in FIG. 3 without transmitting the guide route to user terminal 200. In this case, when information providing server 100 determines that there is no predicted area through which the guide route passes (step S9 in FIG. 3), information providing server 100 transmits the guide route to user terminal 200, and thereafter executes steps S6 to S9 in FIG. 3. When it is determined that there is a predicted area through which the guide route passes (step S9 in FIG. 3), the information providing server 100 sets a dangerous area and calculates an avoidance route, and transmits the guide route and information on the dangerous area to user terminal 200. Accordingly, when the user inputs the departure point and the arrival point to user terminal 200, if the dangerous area is already set, user terminal 200 can display the avoidance route, the dangerous area, and the dangerous section with the guide route on display apparatus 280.

The scope of the present invention is defined not by the above-described meaning but by the claims, and is intended to include meanings equivalent to the claims and all modifications within the scope.

### REFERENCE SIGNS LIST

1 information providing system
10 weather information database
20 road traffic information database
30 hazard map information database
40 probe information database
50 road traffic information collection server
60 disaster information collection server
70 collection database
100 information providing server (server)
100a dynamic information acquiring unit
100b static information acquiring unit
100c setting unit
100d communication control unit
100e route setting unit
110 processor
120 nonvolatile memory
130 volatile memory
140 input/output interface
150 information providing program
200 user terminal (mobile terminal)
200a display unit
210 processor
220 nonvolatile memory
230 volatile memory
240 input/output interface
250 display program
260 wireless communication apparatus
270 speaker
280 display apparatus
281 display screen
300 wide area network
A predicted area
C1 intersection
C2 intersection
C3 intersection
C4 intersection
D dangerous area
E evacuation site
G periphery area
H hazard map
K avoidance route
L1 road link
L2 road link
L3 road link
L4 road link
M dangerous section
S current location
U assumed amount of rainfall

1. An information providing system comprising:
a mobile terminal; and
a server capable of communicating with the mobile terminal,
the server including:
a dynamic information acquiring unit configured to sequentially acquire dynamic information including location information of the mobile terminal and weather information of an area where the mobile terminal is located;
a static information acquiring unit configured to acquire static information including hazard map information indicating a predicted area where occurrence of a weather disaster in an assumed weather state is predicted, the assumed weather state being a weather state in which the occurrence of the weather disaster is predicted;
a setting unit configured to set a dangerous area in the predicted area based on the dynamic information and the static information, the dangerous area being an area where an user of the mobile terminal is likely to be at risk; and
a communication control unit configured to transmit information on the dangerous area to the mobile terminal, wherein
the setting unit is configured to set the dangerous area before a weather state indicated by the sequentially acquired information becomes the assumed weather state.

2. The information providing system according to claim 1, wherein
the server further includes a route setting unit configured to set a guide route based on a departure point and an arrival point provided from the mobile terminal, and
the setting unit is configured to set, as the dangerous area, an area through which the guide route passes in a travel direction from a location of the mobile terminal in the predicted area.

3. The information providing system according to claim 2, wherein
the mobile terminal includes a display unit configured to display the information on the dangerous area that has been received,
the route setting unit is configured to set, in response to the dangerous area being set, an avoidance route for avoiding a dangerous section passing through the dangerous area in the guide route,
the information on the dangerous area includes information indicating the dangerous section and information indicating the avoidance route, and
the display unit is configured to display the avoidance route and the dangerous section so as to be superimposed on a map image in mutually different display forms.

4. The information providing system according to claim 1, wherein
the weather state includes an amount of rainfall,
the predicted area is an area where occurrence of a weather disaster caused by rainfall is predicted, and
the assumed weather state includes an assumed amount of rainfall.

5. The information providing system according to claim 4, wherein
the setting unit is configured to set the dangerous area if the amount of rainfall is greater than a predetermined threshold, and
the predetermined threshold is less than the assumed amount of rainfall.

6. The information providing system according to claim 3, wherein
the weather state includes an amount of rainfall,
the predicted area is an area where occurrence of a weather disaster caused by rainfall is predicted,
the assumed weather state includes an assumed amount of rainfall,
the communication control unit is configured to transmit, if the amount of rainfall is greater than the assumed amount of rainfall, increase information to the mobile terminal, the increase information indicating that the amount of rainfall has increased, and
the display unit is configured to change, in response to receipt of the increase information, the display form of the dangerous section.

7. The information providing system according to claim 1, wherein
the setting unit is configured to set, as the dangerous area, an area overlapping with a periphery area set on a periphery of the mobile terminal in the predicted area.

8. The information providing system according to claim 7, wherein
the mobile terminal includes a display unit configured to display the information on the dangerous area that has been received,
the information on the dangerous area includes location information of the dangerous area, and
the display unit is configured to display the dangerous area and a location of the mobile terminal so as to be superimposed on a map image.

9. The information providing system according to claim 8, wherein
the weather state includes an amount of rainfall,
the predicted area is an area where occurrence of a weather disaster caused by rainfall is predicted,
the assumed weather state includes an assumed amount of rainfall,
the communication control unit is configured to transmit, if the amount of rainfall is greater than the assumed amount of rainfall, increase information to the mobile terminal, the increase information indicating that the amount of rainfall has increased, and
the display unit is configured to change, in response to receipt of the increase information, a display form of the dangerous area.

10. The information providing system according to claim 8, wherein
the weather state includes an amount of rainfall,
the predicted area is an area where occurrence of a weather disaster caused by rainfall is predicted,
the assumed weather state includes an assumed amount of rainfall,
the communication control unit is configured to transmit, if the amount of rainfall is greater than the assumed amount of rainfall, location information to the mobile terminal, the location information being location information of an evacuation site around the mobile terminal.

11. A server capable of communicating with a mobile terminal, the server comprising:
a dynamic information acquiring unit configured to sequentially acquire dynamic information including location information of the mobile terminal and weather information of an area where the mobile terminal is located;
a static information acquiring unit configured to acquire static information including hazard map information indicating a predicted area where occurrence of a weather disaster in an assumed weather state is predicted, the assumed weather state being a weather state in which the occurrence of the weather disaster is predicted;
a setting unit configured to set a dangerous area in the predicted area based on the dynamic information and the static information, the dangerous area being an area where an user of the mobile terminal is likely to be at risk; and
a communication control unit configured to transmit information on the dangerous area to the mobile terminal, wherein
the setting unit is configured to set the dangerous area before a weather state indicated by the sequentially acquired information becomes the assumed weather state.

12. An information providing method for providing information to a mobile terminal, the information providing method comprising:
sequentially acquiring dynamic information including location information of the mobile terminal and weather information of an area where the mobile terminal is located;
acquiring static information including hazard map information indicating a predicted area where occurrence of a weather disaster in an assumed weather state is predicted, the assumed weather state being a weather state in which the occurrence of the weather disaster is predicted;
setting a dangerous area in the predicted area based on the dynamic information and the static information, the dangerous area being an area where an user of the mobile terminal is likely to be at risk; and
transmitting information on the dangerous area to the mobile terminal, wherein
in the setting, the dangerous area is set before a weather state indicated by the sequentially acquired information becomes the assumed weather state.

13. A non-transitory computer readable storage medium storing a computer program for causing a computer to execute a process for providing information to a mobile terminal, the computer program causing the computer to execute:
sequentially acquiring dynamic information including location information of the mobile terminal and weather information of an area where the mobile terminal is located;
acquiring static information including hazard map information indicating a predicted area where occurrence of a weather disaster in an assumed weather state is predicted, the assumed weather state being a weather state in which the occurrence of the weather disaster is predicted;
setting a dangerous area in the predicted area based on the dynamic information and the static information, the dangerous area being an area where an user of the mobile terminal is likely to be at risk; and
transmitting information on the dangerous area to the mobile terminal, wherein
in the setting, the dangerous area is set before a weather state indicated by the sequentially acquired information becomes the assumed weather state.
